(19) United States
(12) Patent Application Publication
(10) Pub. No.: US 2015/0309567 A1
(43) Pub. Date: Oct. 29, 2015

(54) DEVICE AND METHOD FOR TRACKING GAZE

(71) Applicant: KOREA INSTITUTE OF SCIENCE AND TECHNOLOGY, Seoul (KR)

(72) Inventors: Ji Hyung PARK, Seoul (KR); Joong Ho LEE, Goyang-si (KR); Chul Woo CHO, Yangju-si (KR)

(73) Assignee: KOREA INSTITUTE OF SCIENCE AND TECHNOLOGY, Seoul (KR)

(21) Appl. No.: 14/325,996

(22) Filed: Jul. 8, 2014

(30) Foreign Application Priority Data
Apr. 24, 2014 (KR) 10-2014-0049145

(51) Int. Cl. G06F 3/01; G02B 27/01; G06K 9/00; G02B 27/00

(52) U.S. Cl. CPC G06F 3/013; G02B 27/0093; G02B 27/0101; G02B 27/0172; G06K 9/00604; G02B 2027/0138; G02B 2027/014; G02B 2027/0178; G06F 2201/805

(57) ABSTRACT

A gaze tracking device includes a first image acquisition unit installed at a right side of a face of a user to acquire a side image of a right eye, a second image acquisition unit installed at a left side of the face of the user to acquire a side image of a left eye, a fixing unit to fix the first image acquisition unit and the second image acquisition unit, and a gaze tracking unit to track a gaze position of the user by deriving a pupil and iris area, a sclera area, and an angle between eyelids from the side image of the right eye and the side image of the left eye. Accordingly, accurate gaze tracking is ensured while realizing a compact and lightweight gaze tracking device.

### CROSS-REFERENCE TO RELATED APPLICATION

This application claims priority to Korean Patent Application No. 10-2014-0049145, filed on Apr. 24, 2014 and all the benefits accruing therefrom under 35 U.S.C. §119, the contents of which in its entirety are herein incorporated by reference.

### BACKGROUND

1. Field

The present disclosure relates to a device and method for tracking a gaze, and more particularly, to a proximity gaze tracking device and method that may be applied to a head mounted display device.

2. Description of the Related Art

Gaze position tracking is a method of detecting a position where a user is looking. Gaze position tracking has some advantages of similarity to an existing protocol for operating a mouse, rapidity with which a position where a user is viewing is immediately pointed to, convenience of providing a role of an input device to a user with hand disability, immersion provided by calibrating a view display based on a gaze direction of a user in a virtual reality environment, and the like.

Typical gaze position tracking methods may be classified into the following four methods.

1) Skin electrodes-based method: calculates a gaze position by measuring a potential difference between a retina and a cornea after attaching electrodes around eyes.

2) Contact lens-based method: calculates a gaze position by attaching a non-slippery lens to a cornea and attaching a magnetic field coil or a mirror thereon.

3) Head mounted display-based method: calculates a gaze position by mounting a small camera below a headband or a helmet.

4) Desktop-based method: calculates a gaze position by installing a rotatable camera or a camera with a zoom function and lightings outside, dissimilar to conventional methods worn on a body of a user.

These methods correspond to a gaze tracking method which obtains images of eyes through a camera located in front of the eyes and uses a location of reflected light from a pupil and a cornea, and because the camera for capturing the eyes is located in front of the eyes, there is a drawback of an increase in device size.

### SUMMARY

In this context, the present disclosure is directed to providing a lightweight gaze tracking device with optimal wearability.

Also, the present disclosure is directed to providing a gaze tracking method for calculating a gaze position of a user using a side image.

To address these issues, a gaze tracking device according to an exemplary embodiment includes a first image acquisition unit installed at a right side of a face of a user to acquire a side image of a right eye, a second image acquisition unit installed at a left side of the face of the user to acquire a side image of a left eye, a fixing unit to fix the first image acquisition unit and the second image acquisition unit, and a gaze tracking unit to track a gaze position of the user by deriving a pupil and iris area, a sclera area, and an angle between eyelids from the side image of the right eye and the side image of the left eye.

In an exemplary embodiment of the present disclosure, the gaze tracking unit may include a horizontal gaze angle calculation unit to calculate a horizontal gaze angle of the user using a ratio of the pupil and iris area to the sclera area, and a vertical gaze angle calculation unit to calculate a vertical gaze angle of the user using a ratio of an angle between an upper eyelid of the user and a reference line to an angle between a lower eyelid of the user and the reference line.

In an exemplary embodiment of the present disclosure, the gaze tracking unit may further include a final gaze position calculation unit to calculate a final gaze position of the user by combining the horizontal gaze angle and the vertical gaze angle.

In an exemplary embodiment of the present disclosure, the gaze tracking device may further include a position information output unit to output the gaze position of the user as direction information or input information.

In an exemplary embodiment of the present disclosure, the gaze tracking device may be a head mounted display (HMD) device.

In an exemplary embodiment of the present disclosure, the fixing unit may be a frame in a shape of eye glasses.

To address these issues, a gaze tracking method according to another exemplary embodiment includes acquiring each of a side image of a right eye and a side image of a left eye of a user, detecting a pupil and iris area and a sclera area from the side image of the right eye and the side image of the left eye, calculating a horizontal gaze angle of the user using a ratio of the pupil and iris area to the sclera area, measuring an angle between eyelids from the side image of the right eye and the side image of the left eye, calculating a vertical gaze angle of the user using a ratio of an angle between an upper eyelid of the user and a reference line to an angle between a lower eyelid of the user and the reference line, and calculating a final gaze position of the user from the horizontal gaze angle and the vertical gaze angle.

In an exemplary embodiment of the present disclosure, the gaze tracking method may further include outputting the gaze position of the user as direction information or input information.

In another aspect, there is provided a computer-readable recording medium having a computer program recorded thereon for performing the gaze tracking method.

According to the gaze tracking device and method, images of eyes are captured from the sides of the eyes, a horizontal gaze angle is calculated using a ratio of a pupil and iris area to a sclera area, and a vertical gaze angle is calculated using angle ratio information between eyelids. Accordingly, by implementing a compact and lightweight gaze tracking device, a device with optimal wearability may be provided. Also, accurate gaze tracking is ensured, and thus, the present disclosure may replace an existing input device or may be applied to a device and system for analyzing a behavioral pattern of a user.

### BRIEF DESCRIPTION OF THE DRAWINGS

FIG. 1 is a conceptual diagram illustrating a gaze tracking device according to an exemplary embodiment of the present disclosure.

FIG. 2 is a block diagram illustrating a gaze tracking device according to an exemplary embodiment of the present disclosure.

FIG. 3 is a detailed block diagram illustrating a gaze tracking unit of FIG. 2.

FIG. 4 is a diagram illustrating calculation of a horizontal gaze angle.

FIG. 5 is a diagram illustrating calculation of a vertical gaze angle.

FIG. 6 is a flowchart illustrating a gaze tracking method according to an exemplary embodiment of the present disclosure.

### DETAILED DESCRIPTION

The following detailed description of the present disclosure is provided with reference to the accompanying drawings, in which particular embodiments by which the present disclosure may be practiced are shown for illustration. These embodiments are described in sufficient detail to enable those skilled in the art to carry out the invention. It should be understood that various embodiments of the present disclosure are different but do not need to be mutually exclusive. For example, a particular shape, structure, and feature as stated herein may be implemented as a different embodiment in relation to one embodiment without departing from the spirit and scope of the present disclosure. Also, it should be understood that various changes may be made on a location or placement of an individual component in each disclosed embodiment without departing from the spirit and scope of the present disclosure. The following detailed description is not taken in the limitative sense, and the scope of the present disclosure, if properly described, is defined only by the appended claims along with the subject matter set forth in the claims and equivalents thereto. In the drawings, like reference numerals indicate identical or similar functions throughout many aspects.

Hereinafter, exemplary embodiments of the present disclosure will be described in more detail with reference to the drawings.

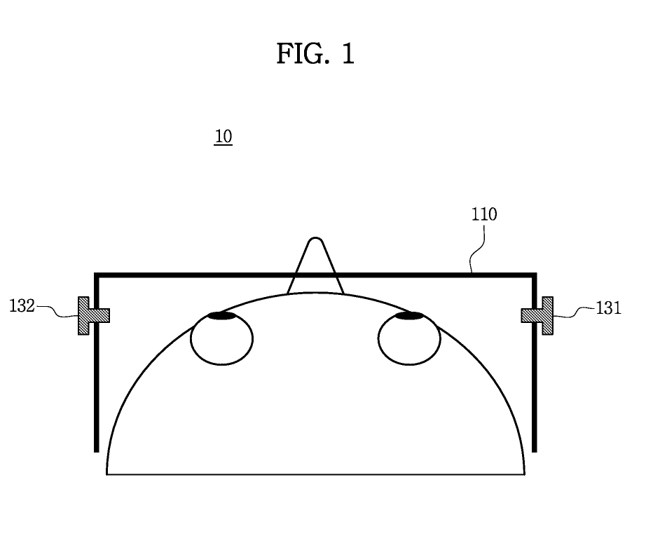

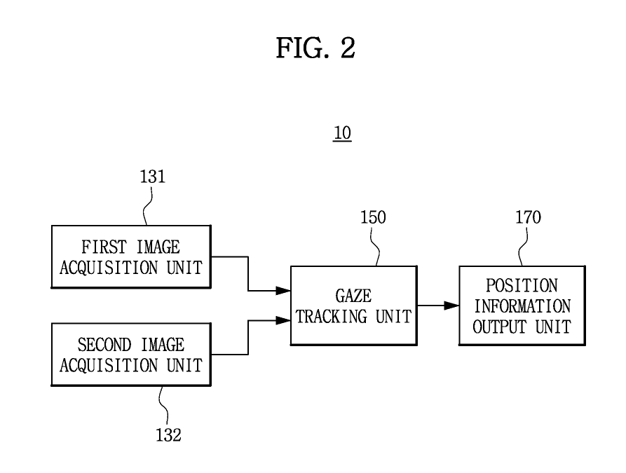

FIG. 1 is a conceptual diagram illustrating a gaze tracking device according to an exemplary embodiment of the present disclosure. FIG. 2 is a block diagram illustrating the gaze tracking device according to an exemplary embodiment of the present disclosure.

Referring to FIGS. 1 and 2, the gaze tracking device 10 according to the present disclosure (hereinafter referred to as a device) may be a head mounted display (HMD) device. An HMD is a type of a display device, worn on the head like eye glasses, that shows an image, and is a next-generation image display device which provides large screen viewing while it is being carried or moved, or is used for operation or diagnosis. However, the type of the device 10 is just an example, and may be provided in various types.

The device 10 may display an image inputted from, for example, an external image output device such as a video player, a TV, and a computer, and a user may enjoy an effect as if the user sees the image on a large screen at a predetermined distance when viewing the image with his/her eyes. Also, the device 10 may be employed to use augmented reality or virtual reality technologies.

Further, the device 10 may control the image by recognizing a gaze of a user to the image as an input or a behavioral pattern. In this instance, it is the most important to find an accurate position by tracking the gaze of the user.

To do so, the device 10 includes a fixing unit 110, a first image acquisition unit 131, a second image acquisition unit 132, and a gaze tracking unit 150.

The fixing unit 110 fixes the first image acquisition unit 131 and the second image acquisition unit 132. The fixing unit 110 may be a frame in a shape of eye glasses. However, the shape of the fixing unit 110 is just an example, and may be provided in various shapes.

The first image acquisition unit 131 is installed at a right side of a face of a user to acquire a side image of a right eye, and the second image acquisition unit 132 is installed at a left side of the face of the user to acquire a side image of a left eye. The first image acquisition unit 131 and the second image acquisition unit 132 may be each a camera formed in proximity to the both sides of the face of the user.

The first image acquisition unit 131 provides the side image of the right eye of the user to the gaze tracking unit 150, and the second image acquisition unit 132 provides the side image of the left eye of the user to the gaze tracking unit 150.

The gaze tracking unit 150 tracks a gaze position of the user by deriving a pupil and iris area, a sclera area, and an angle between eyelids from the side image of the right eye and the side image of the left eye.

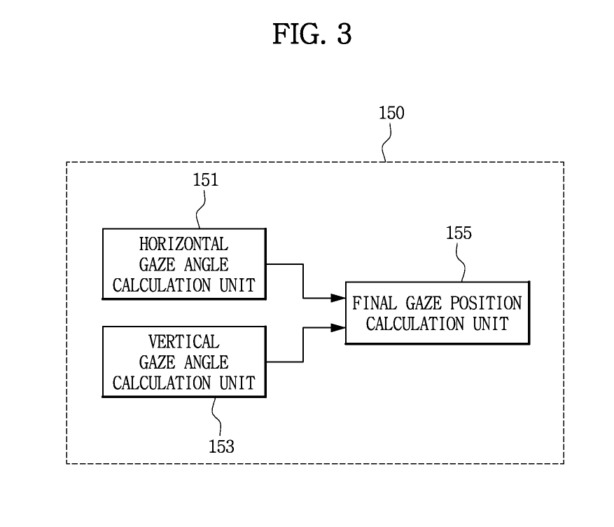

Referring to FIG. 3, the gaze tracking unit 150 includes a horizontal gaze angle calculation unit 151 to calculate a horizontal gaze angle of the user using a ratio of the pupil and iris area to the sclera area, and a vertical gaze angle calculation unit 153 to calculate a vertical gaze angle of the user using the angle between eyelids.

The gaze tracking unit 150 may further include a final gaze position calculation unit 155 to calculate a final gaze position of the user by combining the horizontal gaze angle and the vertical gaze angle.

The horizontal gaze angle calculation unit 151 detects a pupil and iris region and a sclera region from the side image of the right eye and the side image of the left eye, and measures an area of each region.

Subsequently, the horizontal gaze angle calculation unit 151 calculates the horizontal gaze angle of the user by the following Equation 1, using a ratio of the area of the pupil and iris region (Area(P&I)) to the area of the sclera region (Area(S)).

$$Horizontal Gaze Angle , {G}_{H} \approx \frac{Area ( P \& I )}{Area ( S )} \qquad [ Equation 1 ]$$

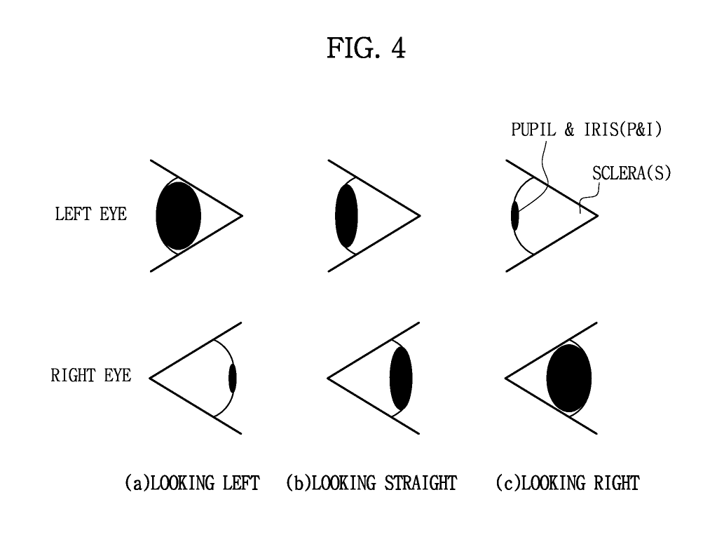

Referring to FIG. 4(a), when looking to the left, in the case of the left eye, the pupil and iris area is larger than the sclera area, compared with when looking straight. In other words, when looking to the left, a ratio of the pupil and iris area to the sclera area in the left eye is high. In this case, as the user looks to the far left, the ratio of the pupil and iris area to the sclera area in the left eye will increase accordingly.

In contrast, when looking to the left, in the case of the right eye, a ratio of the pupil and iris area to the sclera area is low.

Referring to FIG. 4(b), when looking straight, the pupil and iris area and the sclera area are similar, no matter whether the left eye or the right eye.

Referring to FIG. 4(c), when looking to the right, in the case of the right eye, the pupil and iris area is larger than the sclera area, compared with when looking straight. In other words, when looking to the right, a ratio of the pupil and iris area to the sclera area in the right eye is high. In this case, as the user looks to the far right, the ratio of the pupil and iris area to the sclera area in the right eye will increase accordingly.

In contrast, when looking to the right, in the case of the left eye, a ratio of the pupil and iris area to the sclera area is low.

In this way, the horizontal gaze angle G_{H} of the user may be calculated using a change in ratio of the pupil and iris area to the sclera area. The horizontal gaze angle G_{H} is parallel to a horizontal plane, and a line passing through a center of the pupil of the right eye and a center of the pupil of the left eye of the user may be set as a reference line. That is, based on the ratio of the pupil and iris area to the sclera area, how much a gaze was moved to the left or right from the reference line may be calculated.

The vertical gaze angle calculation unit 153 measures an angle between eyelids from the side image of the right eye and the side image of the left eye. The angle between eyelids corresponds to an angle θ_{T} between an upper eyelid of the user and the reference line and an angle θ_{B} between a lower eyelid of the user and the reference line.

The vertical gaze angle calculation unit 153 calculates a vertical gaze angle of the user by the following Equation 2, using a ratio of the angle θ_{T} between the upper eyelid of the user and the reference line to the angle θ_{B} between the lower eyelid of the user and the reference line.

$$Vertical Gaze Angle , {G}_{V} \approx \frac{{θ}_{T}}{{θ}_{B}} \qquad [ Equation 2 ]$$

The vertical gaze angle Gᵥ is parallel to the horizontal plane, and a line passing through outer corners of the eyes of the user may be set as a reference line. The reference line may be preset in a calibration process of the present disclosure.

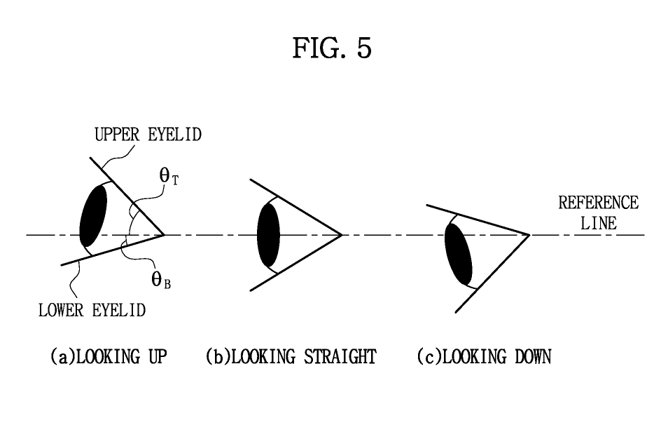

Referring to FIG. 5(a), when looking up, a ratio of the angle θ_{T} between the upper eyelid and the reference line to the angle θ_{B} between the lower eyelid and the reference line is higher than when looking straight. In other words, when looking up, the angle θ_{T} between the upper eyelid and the reference line is larger than the angle θ_{B} between the lower eyelid and the reference line. In this case, as the user looks further up, the ratio of the angle θ_{T} between the upper eyelid and the reference line to the angle θ_{B} between the lower eyelid and the reference line will increase accordingly.

Referring to FIG. 5(b), when looking straight, the angle θ_{T} between the upper eyelid and the reference line and the angle θ_{B} between the lower eyelid and the reference line may be similar.

Referring to FIG. 5(c), when looking down, the ratio of the angle θ_{T} between the upper eyelid and the reference line to the angle θ_{B} between the lower eyelid and the reference line is lower than when looking straight. In other words, when looking down, the angle θ_{T} between the upper eyelid and the reference line is smaller than the angle θ_{B} between the lower eyelid and the reference line. In this case, as the user looks further down, the ratio of the angle θ_{T} between the upper eyelid and the reference line to the angle θ_{B} between the lower eyelid and the reference line will decrease accordingly.

In this way, the vertical gaze angle Gᵥ of the user may be calculated using a change in angle between eyelids. That is, based on the ratio of the angle θ_{T} between the upper eyelid and the reference line to the angle θ_{B} between the lower eyelid and the reference line, how much a gaze was moved up or down from the reference line may be calculated.

The final gaze position calculation unit 155 calculates a final gaze position of the user by combining the horizontal gaze angle G_{H} of the user provided from the horizontal gaze angle calculation unit 151 and the vertical gaze angle Gᵥ of the user provided from the vertical gaze angle calculation unit 153.

The device 10 may further include a position information output unit 170 to output the gaze position of the user as direction information or input information. In this case, the device 10 may use the gaze position of the user as an input signal or a control signal.

The present disclosure calculates the gaze position of the user using the ratio of the pupil and iris area to the sclera area and the angle ratio information between the eyelids from the side images of the eyes, as opposed to a conventional gaze tracking method using location information of pupils from front images of eyes. Accordingly, the gaze position of the user may be tracked accurately in a simple manner, thereby improving the performance of the device and contributing to minimization and weight reduction of the device.

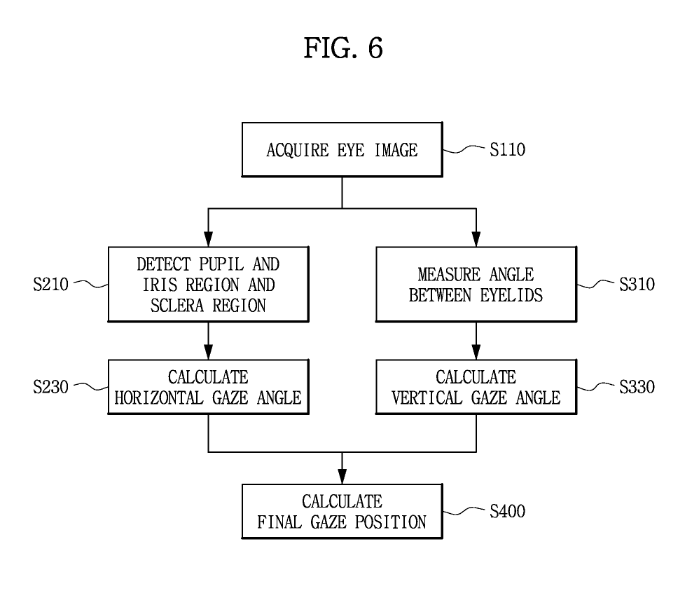

FIG. 6 is a flowchart illustrating a gaze tracking method according to an exemplary embodiment of the present disclosure.

The gaze tracking method according to this embodiment may be performed in the substantially same construction of the device 10 of FIG. 1. Accordingly, the same element of the device 10 of FIG. 1 is assigned the same reference numeral, and a repeated description is omitted.

Alternatively, the gaze tracking method according to this embodiment may be executed by software (application) for gaze tracking.

Referring to FIG. 6, according to the gaze tracking method according to this embodiment, a side image of a right eye and a side image of a left eye of a user are acquired (S100).

Subsequently, a pupil and iris area and a sclera area are calculated from the side image of the right eye and the side image of the left eye (S210), and from this, a horizontal gaze angle of the user is calculated (S230).

Specifically, a ratio of the pupil and iris area (Area(P&I)) to the sclera area (Area(S)) is calculated, and based on the ratio, a horizontal gaze angle is calculated with respect to a reference line.

On the other hand, an angle between eyelids is measured from the side image of the right eye and the side image of the left eye (S310), and from this, a vertical gaze angle of the user is calculated (S330).

Specifically, a ratio of an angle θ_{T} between an upper eyelid of the user and a reference line to an angle θ_{B} between a lower eyelid of the user and the reference line is calculated, and based on the ratio, a vertical gaze angle is calculated with respect to the reference line.

The calculating of the horizontal gaze angle of the user (S230) and the calculating of the vertical gaze angle of the user (S330) may be performed concurrently, or in a sequential order or an arbitrary order.

When the horizontal gaze angle and the vertical gaze angle are calculated, a final gaze position of the user is calculated from the horizontal gaze angle and the vertical gaze angle (S400).

Also, the gaze position of the user is outputted as direction information, and the device may be controlled using the gaze position as an input signal.

As such, the gaze tracking method may be embodied as an application or a computer instruction executable through various computer components recorded in computer-readable recording media. The computer-readable recording media may include a computer instruction, a data file, a data structure, and the like, singularly or in combination.

The computer instruction recorded in the computer-readable recording media may be not only a computer instruction designed or configured specially for the present disclosure, but also a computer instruction available and known to those skilled in the field of computer software.

The computer-readable recording media includes hardware devices specially configured to store and execute a computer instruction, for example, magnetic media such as hard disks, floppy disks, and magnetic tape, optical media such as CD ROM disks and digital video disc (DVD), magneto-optical media such as floptical disks, read-only memory (ROM), random access memory (RAM), flash memories, and the like.

The computer instruction may include, for example, a high level language code executable by a computer using an interpreter or the like, as well as machine language code created by a compiler or the like. The hardware device may be configured to operate as at least one software module to perform processing according to the present disclosure, or vice versa.

While the present disclosure has been described hereinabove with reference to the exemplary embodiments, it will be apparent to those skilled in the art that various modifications and changes may be made without departing from the spirit and scope of the present disclosure set forth in the appended claims.

Recently, there is a demand for the spread of a new technology for gaze tracking from a wearable computer device such as Google Glass, and thus, the gaze tracking device and method according to the present disclosure is expected to be widely used. Also, minimization and lighter weight of a device that could not be realized by an existing gaze tracking device are achieved through the present disclosure, hence technical spillover effects of related products are expected to be very high.

What is claimed is:

1. A gaze tracking device, comprising:
a first image acquisition unit installed at a right side of a face of a user to acquire a side image of a right eye;
a second image acquisition unit installed at a left side of the face of the user to acquire a side image of a left eye;
a fixing unit to fix the first image acquisition unit and the second image acquisition unit; and
a gaze tracking unit to track a gaze position of the user by deriving a pupil and iris area, a sclera area, and an angle between eyelids from the side image of the right eye and the side image of the left eye.

2. The gaze tracking device according to claim 1, wherein the gaze tracking unit comprises:
a horizontal gaze angle calculation unit to calculate a horizontal gaze angle of the user using a ratio of the pupil and iris area to the sclera area; and
a vertical gaze angle calculation unit to calculate a vertical gaze angle of the user using a ratio of an angle between an upper eyelid of the user and a reference line to an angle between a lower eyelid of the user and the reference line.

3. The gaze tracking device according to claim 2, wherein the gaze tracking unit further comprises:
a final gaze position calculation unit to calculate a final gaze position of the user by combining the horizontal gaze angle and the vertical gaze angle.

4. The gaze tracking device according to claim 1, further comprising:
a position information output unit to output the gaze position of the user as direction information or input information.

5. The gaze tracking device according to claim 1, wherein the gaze tracking device is a head mounted display (HMD) device.

6. The gaze tracking device according to claim 1, wherein the fixing unit is a frame in a shape of eye glasses.

7. A gaze tracking method, comprising:
acquiring each of a side image of a right eye and a side image of a left eye of a user;
detecting a pupil and iris area and a sclera area from the side image of the right eye and the side image of the left eye;
calculating a horizontal gaze angle of the user using a ratio of the pupil and iris area to the sclera area;
measuring an angle between eyelids from the side image of the right eye and the side image of the left eye;
calculating a vertical gaze angle of the user using a ratio of an angle between an upper eyelid of the user and a reference line to an angle between a lower eyelid of the user and the reference line; and
calculating a final gaze position of the user from the horizontal gaze angle and the vertical gaze angle.

8. The gaze tracking method according to claim 7, further comprising:
outputting the gaze position of the user as direction information or input information.

9. A computer-readable recording medium having a computer program recorded thereon for performing the gaze tracking method according to claim 7.
